(19) United States
(12) Patent Application Publication
(10) Pub. No.: US 2026/0341147 A1
(43) Pub. Date: Oct. 29, 2026

(54) SINGLE PAIR POWER AND BROADBAND DATA IMPLEMENTATION WITH LINE AND EARTH FAULT SUPERVISION

(71) Applicant: TYCO FIRE & SECURITY GMBH, Neuhausen am Rheinfall (CH)

(72) Inventors: Paul H. MAIER, JR., Athol, MA (US); Wesley J. DECHRISTOFARO, Fitchburg, MA (US)

(21) Appl. No.: 19/190,011

(22) Filed: Apr. 25, 2025

(51) Int. Cl. G08B 29/12; G08B 17/00

(52) U.S. Cl. CPC G08B 29/123; G08B 17/00

(57) ABSTRACT

In an aspect, a fire alarm system using a single wire pair is provided. The fire alarm system includes source side circuitry having a data communication interface configured to couple to the single wire pair, a power communication interface configured to couple to the single wire pair, and fault detection circuitry configured to detect specific power-related faults occurring on the single wire pair. The data communication interface and the power communication interface respectively communicate data and power over the single wire pair.

### TECHNICAL FIELD

Aspects of the present disclosure relate generally to power and data transmission and, more particularly, to a single pair power and broadband data implementation with line and earth fault supervision.

### BACKGROUND

Power over data line (PoDL) is an approach for providing power and data over a single wire pair. PoDL eliminates the need for separate power cables, which simplifies cabling, reduces weight, and cuts costs in applications such as fire alarm systems. Gigabit Home Networking (G.hn) is an example of a communication standard that can optionally work with power over data lines. G. hn is a wired networking standard that enables high-speed, reliable connectivity over existing wiring infrastructure like power lines, coaxial cables, and telephone lines. 10Base-T1L (T1L) is another communication standard that allows for Ethernet communication over a single, twisted pair cable, enabling long-distance connectivity (up to 1 kilometer) at 10 Mbps. However, all known approaches involving a single wire pair for applications such as fire alarm systems lack self-detection capabilities with respect to faults relating to the powered single wire pair. Accordingly, there is a need for a single wire pair implementation of a fire alarm system having self-detection capabilities with respect to faults relating to the single wire pair.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to an aspect of the disclosure, a fire alarm system using a single wire pair is provided. The fire alarm system includes source side circuitry having a data communication interface configured to couple with the single wire pair, a power communication interface configured to couple to the single wire pair, and fault detection circuitry configured to detect specific power-related faults occurring on the single wire pair. The data communication interface and the power communication interface respectively communicate data and power over the single wire pair.

According to another aspect of the present disclosure, a method is provided for, in turn, providing data and power over a single wire pair in a fire alarm system. The method includes coupling, by a data communication interface of source side circuitry, the single wire pair to a data communication circuit. The method further includes coupling, by a power communication interface of the source side circuitry, the single wire pair to a DC power source. The method also includes detecting, by fault detection circuitry of the source side circuitry, specific power-related faults occurring on the single wire pair. The data communication interface and the power communication interface respectively communicate data and power over the single wire pair.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which.

FIG. 1 is a block diagram showing a fire notification system, also referred to as “a fire alarm system,” in accordance with an example aspect.

FIG. 2 is a block diagram showing an exemplary G. hn-based fire alarm system, in accordance with an example aspect.

FIG. 3 is a block diagram showing a further detailed example of the source side circuitry and the repeater of the G. hn-based fire alarm system of FIG. 1, in accordance with an example aspect.

FIG. 4 is a block diagram showing a portion of the G. hn-based fire alarm system of FIG. 1, in accordance with an example aspect.

FIGS. 5-8 are flow diagrams showing a method for providing data and power over a single wire pair in a fire alarm system, in accordance with example aspects.

### DETAILED DESCRIPTION

Aspects of the present disclosure are directed to a single wire pair power and broadband data implementation with line and Earth fault supervision.

Aspects of the present disclosure are directed to networked fire alarm systems having two or more connected fire alarm control panels (FACPs) via a twisted copper wire pair. The use of a single copper pair is beneficial by increasing the opportunity to reuse existing wiring, without requiring the cost/effort of adding additional wires, or installing fiber optic cables

In one or more aspects, circuitry within or at a FACP can be used to detect Earth ground faults and line faults including open circuit faults, short circuit faults, and overload faults. In one or more aspects, a test voltage is used by circuitry at or in a first FACP to determine if an expected second FACP is present on a line and, once confirmed, an operating voltage higher than the test voltage may be applied on the line. In this way, device functionality can be preserved in the case of connecting incorrect FACPs and in the case of faults occurring on the twisted wire pair connecting two or more FACPs.

In an aspect, a specific type of fault is indicated from among different types of expected faults including, but not limited to, Earth ground faults, open circuit shorts, short circuit shorts, and overload shorts. In this way, a troubleshooter can know what type of fault is the cause of a malfunction or the result of a detection.

In one or more aspects, supervised repeaters are connected between two FACPs to extend the distance between the FACPs while still using a single pair of copper wires. Aspects of the present disclosure allow broadband communication over distances greater than otherwise achievable with simply copper wiring.

Aspects of the present disclosure relate primarily to broadband communications using a single twisted copper wire pair. In an aspect, power over data line (PoDL) technology may be used. In an aspect, a 10BASE-T1L (T1L) based implementation of PoDL may be used. In another aspect, a Gigabit Home Networking (G. hn) based implementation of PoDL may be used. It is to be appreciated that aspects of the present disclosure can be implemented based on any technologies, protocols, or standards that involve a single twisted copper wire pair to connect two or more FACPs.

Aspects of the present disclosure may involve a transformer-coupled network with Direct Current (DC) blocking capacitors.

A transformer coupled network is a circuit that uses a transformer to connect multiple stages of an amplifier and/or other circuits. A transformer is used to couple circuits because a transformer provides good impedance matching, noise immunity, and isolation over long distances. A transformer transfers energy from a primary coil to a secondary coil through a magnetic field without any direct electrical connection between the primary and secondary coils. A transformer works by using the principle of electromagnetic induction, where a changing magnetic field created by an alternating current (AC) flowing through a primary coil induces a voltage in a secondary coil, allowing for the transformation of voltage levels between the two circuits based on the ratio of turns on each of the coils.

A DC-blocking capacitor, often referred to as an AC-coupling capacitor, is a passive electronic device designed to allow AC signals to pass while blocking DC components from a circuit. A DC-blocking capacitor may be used to block any DC components, for example, to the secondary coil.

Aspects of the present disclosure apply system power (typically DC) to the communication lines through an inductive path (to maintain a relatively high impedance between the power path and the communication path). The system power, applied to the wires, can be used to provide power to one or more communications repeaters. For example, in an aspect, a communications repeater is inserted midway in the wiring run. The repeater then boosts and re-generates the communication signal for an additional distance. While a single repeater is mentioned in the preceding aspect, it is to be appreciated that multiple repeaters may be used to enable communications over additional extended distances in other aspects.

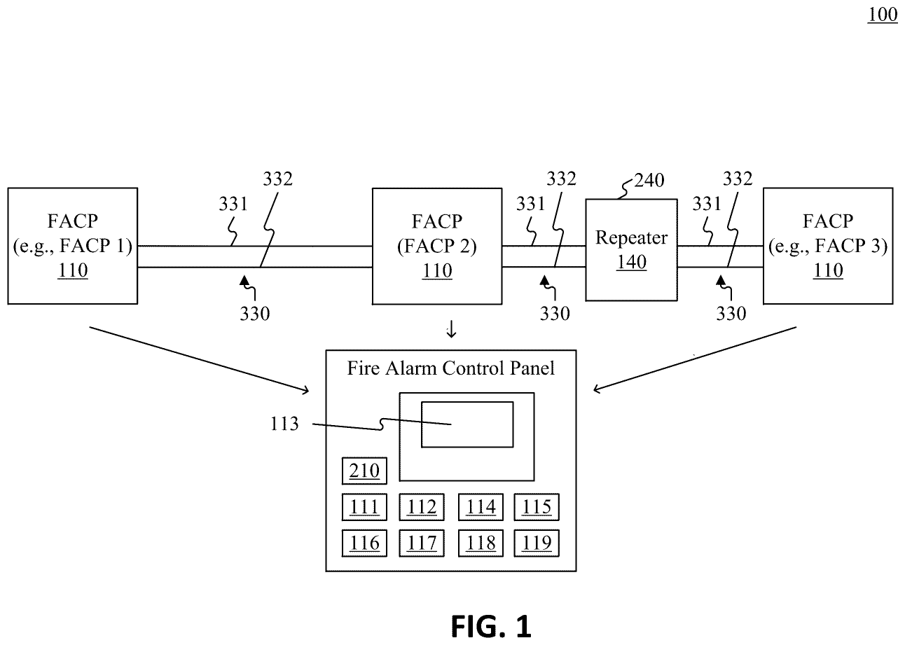

Referring now to FIG. 1, a fire notification system 100, also referred to as “a fire alarm system,” is shown, in accordance with an example aspect. Fire notification system 100 is a system for providing notification in the case of a fire.

In accordance with various aspects of the disclosure, fire notification system 100 includes multiple (two or more) fire alarm control panels (FACP) 110 coupled together and also with remote devices (not shown) by communication media.

FACPs 110 can be considered as a local control centers of fire notification system 100 in that remote devices are in signal communication with and “report” to FACPs 110 so that one or more actions may be performed by FACPs 110 in response to, for example, the reporting of a detection of a fire by one or more of remote devices. In an aspect, one or more actions that may be performed by FACPs 110 include reporting the detection of a fire (and/or other emergency condition) to a remote location (e.g., a remote control center, a local fire alarm station, and/or so forth). In an aspect, the one or more actions that may be performed by FACPs 110 include initiating a response and/or action by another system in signal communication with the FACPs 110 such as a fire suppression system. The performance of actions by FACPs 110 and the reporting of the occurrence of an emergency by at least one of remote devices can be based on one or more on-board algorithms of FACPs 110.

In an aspect, FACPs 110 further include one or more of: one or more connection ports 112 for connecting to an external device (e.g., a tablet, a diagnostic device, and so forth); one or more input/output (I/O) devices 113 for receiving user inputs and providing system outputs; a transceiver 114 for wireless receiving and transmitting information, for example, to a remote fire notification system with respect to fire notification system 100; one or more speakers 115 for confirming receipts of inputs/commands and reporting fire notification system 100 data; a microphone 116 for receiving verbal commands; and/or one or more light sources (light emitting diodes, etc.) 117 for confirming receipts of inputs/commands and reporting fire notification system data.

In various aspects, one or more I/O devices 113 may include one or more of, e.g.: a touchscreen or other type of display; a keypad for receiving inputs representing characters in a set; a keyboard, e.g., a QWERTY keyboard, for receiving inputs representing characters in a set (including, e.g., letters, numbers, punctation, special characters) as well as commands and so forth; a mouse or other selection device for receiving motion inputs corresponding to a position on a grid of a display and/or a selection of an item corresponding to traversed position on the grid; a camera for capturing facial images for authorization and authentication and/or gestures representing, e.g., commands and/or data (e.g. raising an arm means raising the input value to the system and lowering an arm means lowering the input value to the system); and/or a joystick for receiving motion inputs corresponding to a position on a grid of a display and/or a selection of an item corresponding to traversed position on the grid; and so forth.

In an aspect, FACPs 110 include one or more memories 118, individually or in combination, having instructions. The FACPs 110 include one or more processors 119 each coupled to at least one of the one or more memories 118 and configurable to execute the instructions. The one or more memories 118 and the one or more processors 119 implement remote device UI generator 111 as described in further detail herein.

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Remote devices include devices capable of detecting a fire or other emergency condition and relaying audible, visible, or other stimuli to alert building occupants of the fire or other emergency condition. For example, a remote device can include, but is not limited to, any of the following: a smoke detector; a heat detector; a speaker; a microphone; a buzzer; a fire alarm switch (e.g., a pull switch); a light (e.g., LED); a relay; and so forth

Remote devices can include a light notification module and/or a sound notification module. The light notification module can be implemented as a light emitting device or any component in remote devices that alerts occupants of an emergency by emitting a visible light signal. In some aspects, remote devices emit strobe flashes to alert building occupants of an emergency situation. A sound notification module can be a speaker or any component in remote devices that alerts occupants of an emergency by emitting an audible signal. In some aspects, which should not be construed as limiting, remote devices may emit one or more audible signals.

In an aspect, communication media 330 is configured to at least enable data (e.g., system status) to be received from remote devices by FACP 110 for further action. In an aspect, further action by FACPs 110 may include reporting a system status to a remote location and/or initiating corrective action (e.g., fire suppression) by another system. In an aspect, further action by FACPs 110 may be implemented based on and in accordance with one or more stored algorithms in FACPs 110 that provide various responses to various input cases (e.g., different combinations of remote devices being actuated).

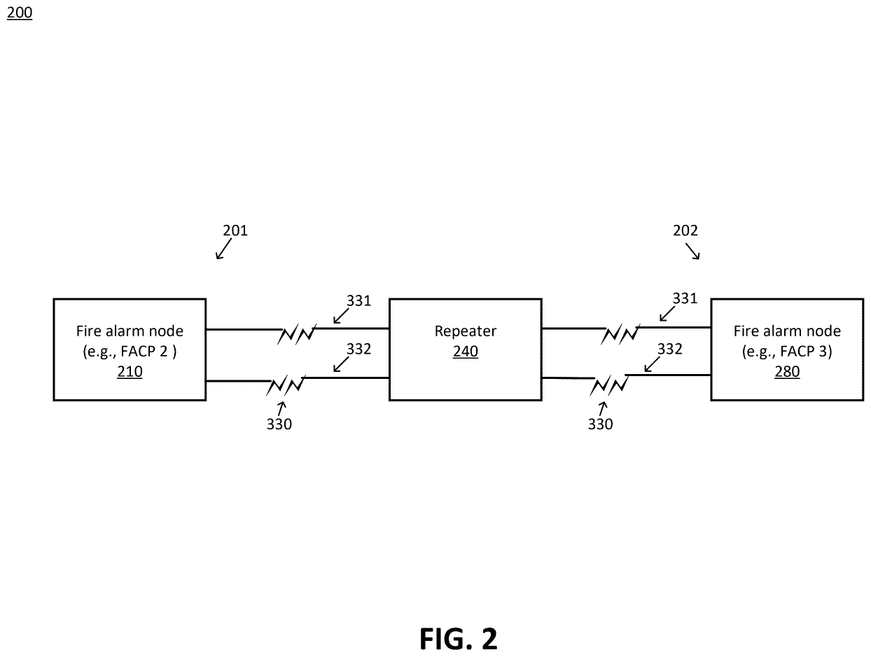

In an aspect, FACPs 110 include source side circuitry 210. In an aspect, source side circuitry 210 provides power and data and receives data from other FACPs 110. Source side circuitry is shown in further detail and described with respect to FIGS. 2-4.

In an aspect, fire alarm system 100 includes one or more repeaters 240 for boosting a signal from the source side circuitry 210 to respective other FACPs 110. One or more repeaters 240 are shown in further detail and described with respect to FIGS. 2-4.

Referring now to FIG. 2, an exemplary G. hn-based fire alarm system 200 is shown, in accordance with an example aspect. In an aspect, G. hn-based fire alarm system 200 corresponds to a G. hn implementation of fire alarm system 100 of FIG. 1. While the fire alarm system 200 of FIG. 2 is described as G. hn based, fire alarm system 200 can be implemented based on other 2 wire protocols. In an aspect, fire alarm system 200 uses two copper wires to convey data and power and is not limited to any particular protocol.

G. hn-based fire alarm system 200 includes source side circuitry 210 at a source side 201 of G. hn-based fire alarm system corresponding to a fire alarm control panel (FACP) such as FACP 110 of FIG. 1, target side circuitry 280 at a target side 202 of G. hn-based fire alarm system corresponding to another FACP such as another FACP 110 of FIG. 1, and one or more repeaters 240 disposed intermediate to source side 201 and target side 202 to boost a “useable distance” between source side circuitry 210 and target side circuitry 280. “Useable distance” refers to, e.g., maintaining a minimum quality of service (QoS) level or other quality metric(s) at both source side 201 and target side 202 with respect to both data communications and power provided and received. Source side circuitry 210 is connected to target side circuitry 280 using communication media (also interchangeable referred to herein as “single wire pair”) 330 that includes a first wire 331 and a second wire 332. In an aspect, first wire 331 and second wire 332 are copper wires.

A repeater is an electronic device in a communication channel that increases the power of a signal and retransmits the signal, allowing the signal to travel further. Repeaters are used to extend transmissions so that the signal can cover longer distances or be received on the other side of an obstruction. Repeating becomes critical for applications with complex network topologies that need to cover large distances, such as those found in industrial or utility applications. The use of repeaters will result in an increased range of up to approximately 1000 meters.

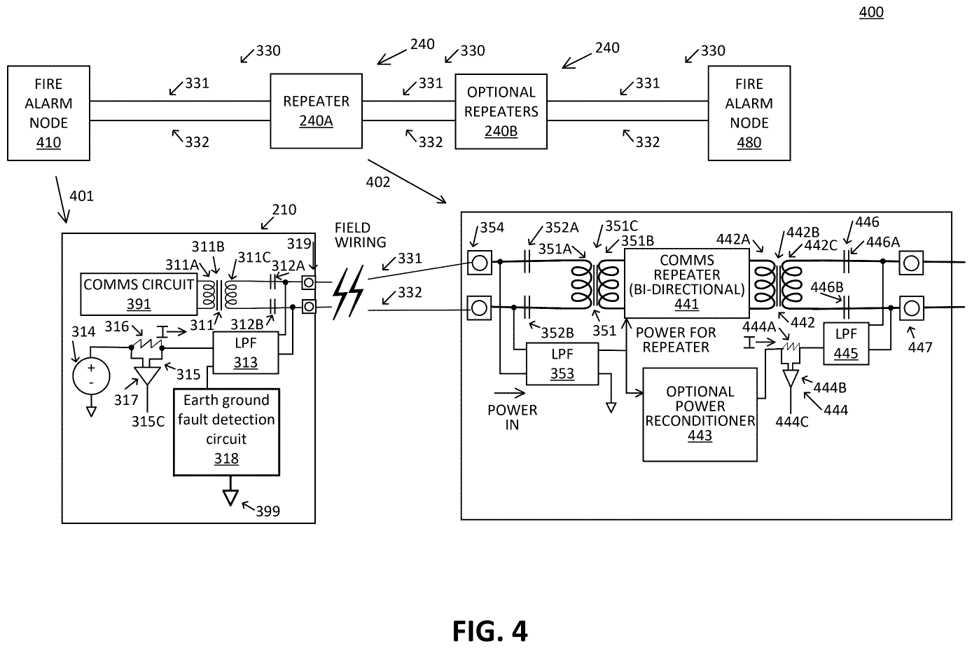

While a single repeater 240 is shown in FIG. 2, in other aspects, multiple repeaters 240 may be used (e.g., as shown in FIG. 4). For example, as a rule, a repeater may be added to G. hn fire alarm system 200 as long as a minimum quality level(s) (e.g., quality of service (QoS) level(s)) is met or exceeded by target side circuitry 280 with respect to both a data communication component and a power communication component. For example, as long as the addition of another repeater 240 does not (i) adversely affect the data communication component by causing a received bitrate by a receiving device to be less than a minimum bitrate (ii) while also not adversely affecting the power communication protocol by preventing a received power by the receiving device to be less than a minimum power level, then the repeater can be considered for safely adding to G. hn fire alarm system 200 in that the addition of repeater 240 will still preserve the system functionality at, e.g., target side 202 with respect to a minimum quality level(s). In some aspects, the values of the QOS levels for both the data communication component and the power communication component are equal. In other aspects, the values of the QoS levels for both the data communication component and the power communication component are unequal.

In an aspect, network delays can be considered when evaluating a minimum quality level. For example, if fire notification data is needed to be reported back to the source side within a given time frame, e.g., per a system requirement and/or a fire reporting standard, then the added delays imposed by adding additional repeaters along the single wire pair can be considered and evaluated in order to determine whether a repeater can be added to G. hn fire alarm system 200 while still complying with the system requirement or the fire reporting standard.

Each of source side circuitry 210, target side circuitry 280, and one or more repeaters 240 include a respective data communication interface for coupling to the single wire pair and a respective power interface for coupling to the communication media 330. In an aspect, source side circuitry 210 is configured to provide power over the communication media 330 with fault detection of specific power-related faults occurring on the single wire pair. Such power-related faults include open circuit faults and Earth ground faults. An open circuit corrresponds to a disconnection in a communication path. An Earth ground fault corresponds to a connection of a communication path to an unintended Earth path.

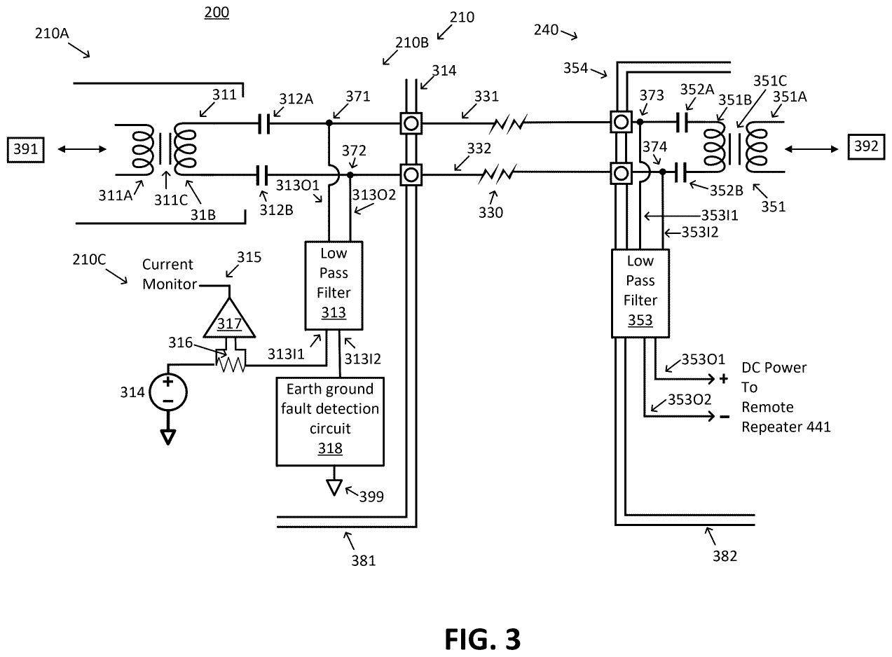

Referring now to FIG. 3, a further detailed example of source side circuitry 210 and repeater 240 of G. hn-based fire alarm system 200 of FIG. 2 is shown, in accordance with an example aspect.

As noted above, G. hn-based fire alarm system 200 includes source side circuitry 210 and repeater 240. In an aspect, source side circuitry 210 corresponds to a local fire alarm control panel portion 381.

Source side circuitry 210 includes a transformer 311 for coupling with communications circuitry 391 to form a transformer coupled network. In an aspect, transformer 311 includes a primary coil 311A for coupling to communications circuitry 391 and a secondary coil 311B for coupling to respective first sides of a pair of direct current (DC) blocking capacitors 312. In an aspect, primary coil 311A couples to communications circuitry 391 to receive broadband data from communications circuitry 391. In an aspect, secondary coil 311B couples to respective first sides of a pair of direct current (DC) blocking capacitors 312A and 312B configured to protect transformer 311 from DC such as from DC power source 314 described below. Transformer 311 may include a core 311C of air or other material (e.g., Iron, etc.).

Communications circuitry 391 may include a device (not shown) for providing broadband data to source side circuitry 210. Communications circuitry 391 includes an Ethernet PHY (to connect to the Ethernet network that natively comes from FACPs 110) that is then connected to a media converter and analog front end that converts the ethernet signals from the FACPs into a single-pair broadband signal (G. hn or other similar standard). This could be a standalone chip or a chipset. The resulting single-pair signal is then driven into the transformer 311. Signals in the opposite direction are received from transformer 311 by that same chip (or chipset) and converted to Ethernet to be sent to the FACP.

DC blocking capacitors 312A and 312B, also known as alternating current coupling capacitors, are passive electronic devices designed to allow alternating current (AC) signals to pass while blocking DC components from a circuit (here, to block or protect secondary coil 311B of transformer 311 from DC (e.g., output from DC power source 314)). Second sides of DC blocking capacitors 312A and 312B are coupled with an output side of a low pass filter 313 having a first output 313O1 for outputting a filtered signal from a DC power source 314 and a second output 313O2 for outputting a filtered signal from Earth ground.

DC power source 314 has a negative terminal connected to Earth ground, and a positive terminal connected to a first side of a current monitoring circuit 315. Current monitoring circuit 315 includes a resistor 316 and a comparator 317 for measuring the voltage across resistor 316 to determine if current is flowing through resistor 316. If current is not flowing through resistor 316, then this would likely indicate the existence of an open circuit condition along the power path. A second side of current monitoring circuit 315 is coupled to a first input 313I1 of low pass filter 313. A second input 313I2 of low pass filter 313 is coupled to Earth ground 399. An Earth ground fault detection circuit 318 is connected between Earth ground 399 and second input 313I2 of low pass filter 313.

A common node 371 formed from a first leg of secondary coil 311B, capacitor 312A of pair of DC blocking capacitors 312A and 312B, and first output 3I3O1 of low pass filter 313 is connected to a first wire 331 of a communication media (e.g., a single wire pair) 330. A common node 372 formed from a second leg of secondary coil 311B, capacitor 312B of pair of DC blocking capacitors 312A and 312B, and second output 313O2 of low pass filter 313 is connected to a second wire 332 of the communication media 330. In an aspect, the communication media comprises a single copper wire pair.

Source side circuitry 210 further includes an impedance network 319 for matching impedance with an impedance network 354 of repeater 240. To achieve optimal power transfer in a DC circuit, the source side impedance should be matched to the load (repeater) side impedance, meaning the source side impedance and repeater side impedance should have the same value. One side of impedance network 319 is connected to the common nodes 371 and 372, and the other side of impedance network 319 is connected to common nodes 373 and 374 through communication media 330. One side of impedance network 354 is connected to the common nodes 373 and 374, and the other side of impedance network 354 is connected to common nodes 371 and 372 through communication media 330.

Repeater 240 includes a transformer 351 for coupling to communications circuitry 392 to form a transformer coupled network. In an aspect, transformer 351 includes a primary coil 351A for coupling to communications circuitry 392 and a secondary coil 351B for coupling to respective first sides of a pair of direct current (DC) blocking capacitors 352A and 352B. In an aspect, primary coil 351A couples to communications circuitry 392 to receive broadband data from communications circuitry 392. In an aspect, secondary coil 351B couples to respective first sides of a pair of direct current (DC) blocking capacitors 352A and 352B configured to protect transformer 351 from DC from communication media 330. Transformer 351 may include a core 351C of air or other material (e.g., Iron, etc.).

Communications circuitry 392 may include a device (not shown) for receiving broadband data from repeater 240. Communications circuitry 392 is the same element as communications repeater 441 in FIG. 4. Both communications circuitry 392 and communications repeater 441 are intended to be an interface to the single-pair comms data (at the transformer 351) which is then converted from analog to its digital contents and then retransmitted by conversion back to its analog single-pair data representation and sent out the repeater's downstream side (once again via a transformer 442).

DC blocking capacitors 352A and 352B block or protect primary coil 351A of transformer 351 from DC from communication media 330. Second sides of DC blocking capacitors 352A and 352B are connected to an input side of a low pass filter 353 having a first input 353I1 for inputting a DC signal from first wire 331 and a second input 353I2 for inputting a DC signal from second wire 332.

A first output 353O1 of low pass filter 353 provides DC power to repeater 240 of remote repeater side 382. A second output 353O2 of low pass filter 353 provides DC power to repeater 240 of remote repeater side 382. In this way, the repeater 240 can be powered from DC power sent from the source side circuitry 210 over the communication media 330.

The common node formed from a first leg of primary coil 351A, capacitor 352A of pair of DC blocking capacitors 352A and 352B, and first input 353I1 of low pass filter 353 is connected to first wire 331 of communication media (e.g., a single wire pair) 330. The common node formed from a second leg of primary coil 351B, capacitor 352B of pair of DC blocking capacitors 352A and 352B, and second input 353I2 of low pass filter 353 is connected to second wire 332 of communication media 330.

In an aspect, a data communication interface 210A of the source side circuitry 210 includes one or more of pair of DC blocking capacitors 312 and transformer 311. In an aspect, a function of data communication interface 210A is to interface communication circuitry 391 to communication media 330. In an aspect, communications between communication circuitry 391 and communication media 330 are bidirectional.

In an aspect, a power communication interface 210B of the source side circuitry 210 includes one or more of LPF 313, Earth ground 399, and power source 314. In an aspect, a function of power communication interface 210B is to interface and/or otherwise provide DC power from DC source 314 to communication media 330.

In an aspect, fault detection circuitry 210C of the source side circuitry 210 includes one or more of LPF 313, Earth ground detection circuit 318, Earth ground 399, current monitoring circuit 315, and power source 314. In an aspect, a function of fault detection circuitry 210C is to detect specific power-related faults occurring on the single wire pair 330 includes configuring one or more of LPF 313, Earth ground detection circuit 318, Earth ground 399, current monitoring circuit 315, and power source 314 to detect line faults and Earth ground faults occurring on the communication media 330 when power is provided. The specific power-related faults include short faults, open faults overload faults, and Earth ground faults. In an aspect, the output of comparator 317 of current monitoring circuit 315

Referring now to FIG. 4, a portion 400 of G. hn-based fire alarm system 200 is shown, in accordance with an example aspect.

Portion 400 includes a fire alarm node 410 connected to another fire alarm node 480 via communication media 330 (copper pair including first copper wire 331 and second copper wire 332). In the aspect of FIG. 4, one or more repeaters 240 are placed between fire alarm node 410 and fire alarm node 480. In particular, one or more repeaters 240 include a repeater 240A and one or more optional repeaters 240B. Fire alarm node 410 corresponds to a first FACP 110 and fire alarm node 480 corresponds to a second FACP 110.

Detail 401 shows the fire alarm node 410 in further detail. In particular, detail 401 shows source side circuitry 210 of FIG. 2. As shown and described with respect to FIG. 3, source side circuitry 210 includes: transformer 311 (with primary coil 311A, secondary coil 311B, and core 311C); DC blocking capacitors 312A, 312B; low pass filter 313; Earth ground fault detection circuit 318; DC power source 314; current monitoring circuit 315 (with resistor 316 and comparator 317); common nodes 371, 372; impedance network 319; and Earth ground fault detection circuit 318.

In an aspect, DC power source 314 can be tied to fire alarm control panel (FACP) power so that Earth fault detection is done by the FACP. In another aspect, DC power source 314 can be an isolated power source where Earth fault detection is done by a local monitor circuit (i.e., Earth ground fault detection circuit 318).

Earth ground fault detection circuitry is configured to identify situations where electrical current is unintentionally flowing to ground (or a grounded object) instead of following the intended path through the circuit. In an aspect, a current transformer (CT) or other device is used to monitor the current flow. The sum of the currents in all conductors, except the protective earth conductor, is measured. In a normal situation, the current flowing into a circuit should equal the current flowing out of it. However, a ground fault introduces an imbalance, as some current is diverted to ground. The Earth ground fault detection circuitry 318 detects this imbalance and, if the current exceeds a predetermined threshold, the Earth ground fault detection circuitry triggers an alarm or initiates protective actions such as opening a circuit to block the flow of current to the one or more repeaters 240 or other downstream circuitry (e.g., another FACP). In an aspect, a microcontroller is connected to DC power source 314 to control its operation such that power is only applied when a proper response (acknowledge) in a handshake process with the repeater 240 and/or the target side circuitry 280. In this way, only intended items (repeaters 140 and/or other FACPs 110) are powered by DC power source 314. Thus, in an aspect, the downstream device could be properly identified before allowing operating power to flow to the downstream device. One possible implementation would be that a lower “test” voltage can be applied to the lines and a well-defined current draw can be used to indicate the presence of a device. In an aspect, a simple end-of-line resistor can be used to indicate the presence of a device. In another aspect, an analog circuit that draws a specific current (so as to mitigate any effects from line resistance) can be used to indicate the presence of a device. Once the downstream device is verified as being a proper recipient of power by the upstream device based on the current drawn being within a controlled range, operating power can then be applied to the lines (communication media 330) instead of the lower “test” voltage.

Detail 402 shows repeater 240A in further detail. Repeater 240A includes the following components described above with respect to FIG. 3: impedance network 354 for matching impedance with impedance network 319; DC blocking capacitors 352A, 352B for allowing AC signals to pass and blocking DC signals coming from communication media 330 to transformer 351; low pass filter 353; and transformer 351 (with primary coil 351A, secondary coil 351B, and core 351C) for coupling communication media 330 to communications circuitry 392.

Repeater 240A further includes: a bi-directional communications repeater 441 for boosting bi-directional communications; a transformer 442 for coupling to bi-directional communications repeater 441 to form a transformer coupled network; an optional power reconditioner (V-boost) 443 for reconditioning the power (e.g., boosting the voltage); a current monitoring circuit 444 (with resistor 444A and comparator 444B) for monitoring current to detect a line fault (e.g., open fault or short fault); a low pass filter (LPF) 445; a pair of DC blocking capacitors 446 (including capacitors 446A, 446B) for allowing AC signals to pass while blocking DC components from a circuit (here, to block or protect secondary coil 351B of transformer 351 from DC (e.g., output from low pass filter 445)); and an impedance network 447 for matching an impedance of an impedance network (not shown) of either optional repeater 240B if used, or fire alarm node 480.

In an aspect, transformer 442 includes a primary coil 442A for coupling to bi-directional communications repeater 441 and a secondary coil 442B for coupling to respective first sides of a pair of direct current (DC) blocking capacitors 446. In an aspect, primary coil 442A couples to bi-directional communications repeater 441 to receive broadband data from bi-directional communications repeater 441. In an aspect, secondary coil 442B couples to respective first sides of a pair of direct current (DC) blocking capacitors 446 configured to protect transformer 442 from DC such as from low pass filter (LPF) 445. Transformer 442 may include a core 442C of air or other material (e.g., Iron, etc.).

In an aspect, current monitoring circuit 315 monitors current to detect line faults (open faults and short faults) and detect whether a repeater is connected before engaging (supplying power). An output of current monitoring circuit 315 is provided on line 315C. In an aspect, current monitoring circuit 444 monitors current to detect line faults (open faults and short faults) and detect whether a repeater or proper target side circuitry is present before engaging (supplying power). An output of current monitoring circuit 444 is provided on line 444C. In an aspect, Earth ground fault detection circuit 318 is implemented by an analog circuit (not shown). In an aspect, Earth ground fault detection circuit 318 is implemented by an Analog-to-Digital Converter (ADC) (not shown) and a microcontroller (not shown).

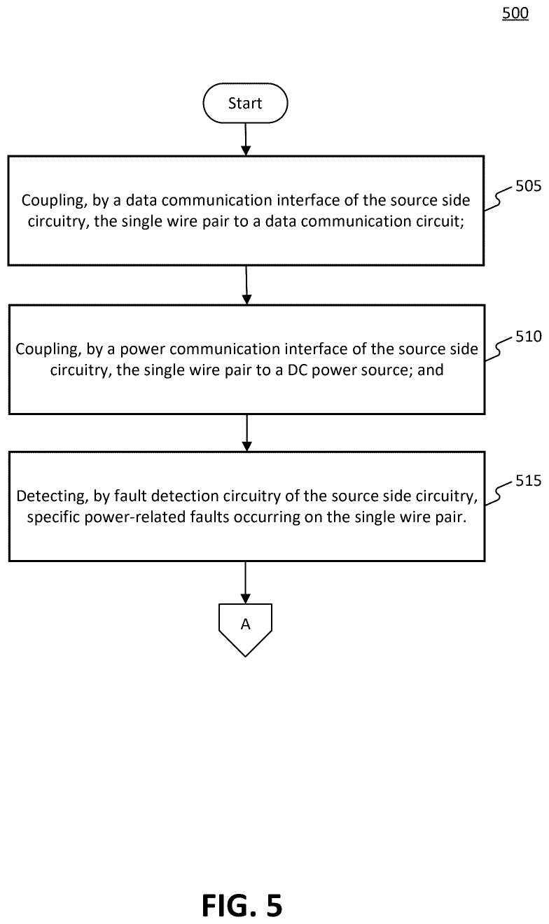

Referring now to FIGS. 5-8, a method 500 for providing data and power over a single wire pair in a fire alarm system is shown, in accordance with example aspect. Boxes shown in dashes or dashes and dots are optional features.

Method 500 may be performed by one or more processors (e.g., one or more processors 119 of FIG. 1), individually or in any combination, operatively coupled to one or more memories (e.g., one or more memories 118 of FIG. 1). The method 500 may be implemented, in part, by computer code (e.g., stored in one or more memories 118 of FIG. 1).

Referring now to FIG. 5, at block 505, the method 500 includes coupling, by a data communication interface 210A of the source side circuitry 210, the single wire pair 330 to a data communication circuit 391.

At block 510, the method 500 includes: coupling, by a power communication interface 210B of the source side circuitry 210, the single wire pair 330 to a DC power source 314.

At block 515, the method 500 includes detecting, by fault detection circuitry 210C of the source side circuitry 210, specific power-related faults occurring on the single wire pair 330.

The data communication interface 210A and the power communication interface 210B respectively communicate data and power over the single wire pair 330.

In an aspect, the source side circuitry 210 is configured to interface with a fire alarm control panel (FACP) 110 of the fire alarm system 100. In an aspect, the source side circuitry 210 is comprised at least one of, within or on, the FACP 110.

In an aspect, the target side circuitry 280 is configured to interface with a another FACP 110 of the fire alarm system 100.

In an aspect, the data communication interface 210A of the source side circuitry 210 and a data communication interface of the target side circuitry 280 are for coupling a respective data communication circuit 391, 392 to the single wire pair 330.

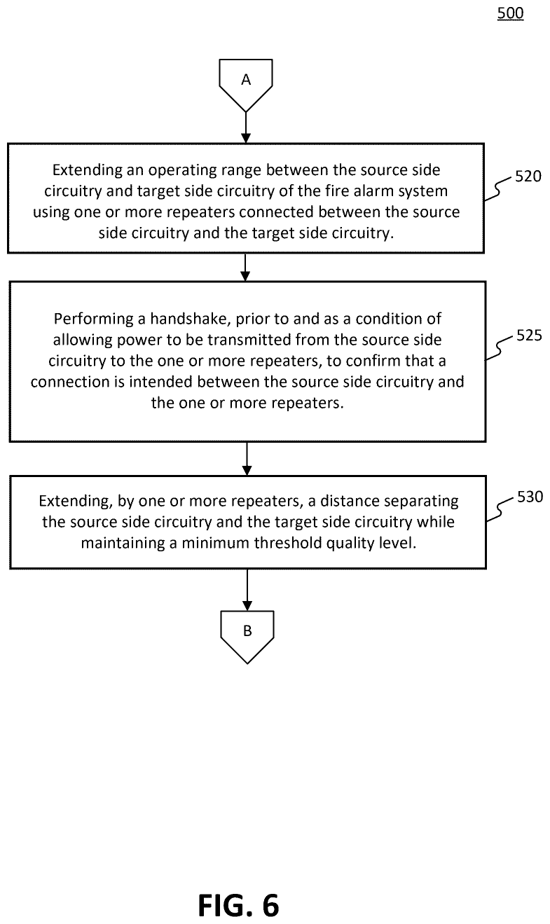

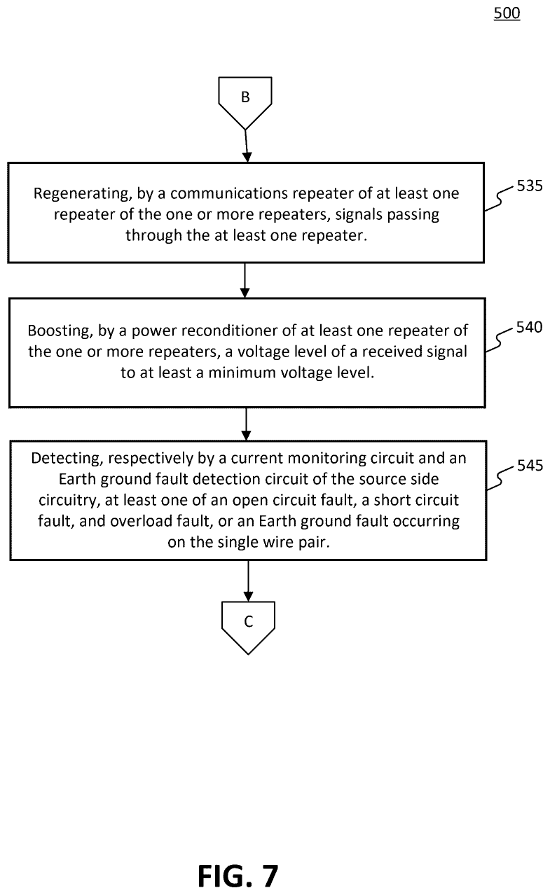

Referring now to FIGS. 6-7, further blocks of method 500 of FIG. 5 are shown, in accordance with an example aspect.

At block 520, the method 500 includes extending an operating range between the source side circuitry and target side circuitry of the fire alarm system using one or more repeaters connected between the source side circuitry and the target side circuitry. In an aspect, block 520 involves boosting a signal strength or power of signals communicated between the source side circuitry 210 and the target side circuitry 280 by connecting one or more repeaters 240 between the source side circuitry 210 and the target side circuitry 280. In an aspect, the one or more repeaters 240 extend a distance separating the source side circuitry 210 and the target side circuitry 280 while maintaining a minimum threshold quality level (e.g., quality of service QoS) level) by, for example, maintaining a minimum power level of power transmitted to target side circuitry 280 or maintaining a packet drop level below a maximum threshold.

At block 525, the method 500 includes performing a handshake, prior to and as a condition of allowing power to be transmitted from the source side circuitry 210 to the one or more repeaters 240, to confirm that a connection is intended between the source side circuitry 210 and the one or more repeaters 240. In an aspect, the handshake may involve confirming a value transmitted from the one or more repeaters 240 to the source side circuitry 210 to confirm that the one or more repeaters 240 are the proper recipient of power from the source side circuitry 210.

At block 530, the method 500 includes extending, by the one or more repeaters, a distance separating the source side circuitry and the target side circuitry while maintaining a minimum threshold quality level. In an aspect, the minimum threshold quality level is based on monitoring at least one of a data communication component and a power communication component of a received signal. In an aspect, the minimum threshold quality level is based on, or further based on, monitoring a delay of a received signal.

At block 535, the method 500 includes regenerating, by a communications repeater 441 of at least one repeater 240A of the one or more repeaters 240, signals passing through the at least one repeater 240A.

At block 540, the method 500 includes boosting, by a power reconditioner 443 of the source side circuitry 210, a voltage level of a received signal to at least a minimum voltage level. In this way, a sufficient degree of power can be passed to a FACP 110 connected the one or more repeaters 240, including factoring in for line and other losses.

At block 545, the method 500 includes detecting at least one of an open circuit fault, a short circuit fault, an overload fault, or an Earth ground fault occurring on the single wire pair 330. In an aspect, block 545 may involve using current monitoring circuit 315 of the source side circuitry 210 to detect open or short or overload faults by comparing voltages at respective ends of a resistor 316 using a comparator 317. In an aspect, block 545 may involve using Earth ground fault detection circuit 318 of the source side circuitry 210 to detect an Earth ground fault by detecting a voltage or current drop that is unexpected and likely indicative of a short to Earth (Earth ground fault).

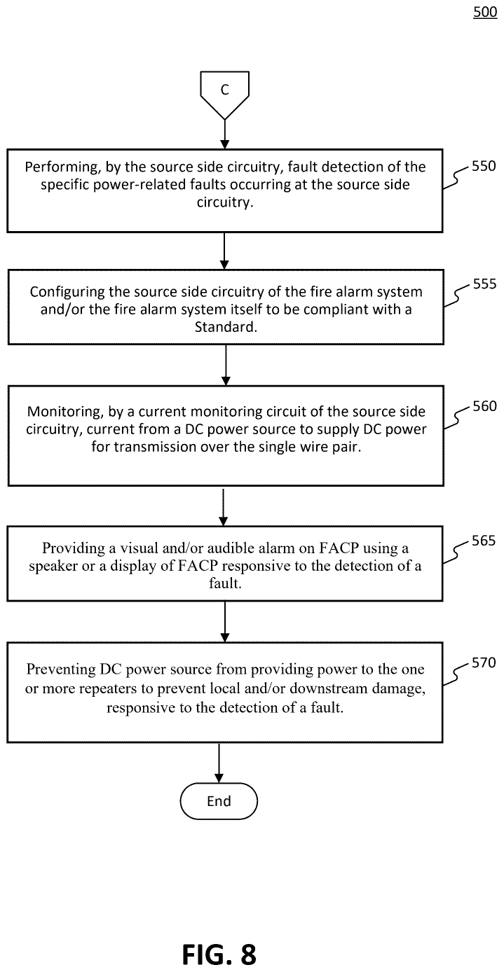

Referring now to FIG. 8, further blocks of method 500 of FIG. 5 are shown, in accordance with an example aspect.

At block 550, the method 500 performing, by the source side circuitry 210, fault detection of the specific power-related faults occurring at the source side circuitry 210. In an aspect, block 550 may involve configuring current monitoring circuit 315 of the source side circuitry 210 to detect open or short or overload faults by comparing voltages at respective ends of a resistor 316 using a comparator 317. In an aspect, block 550 may involve configuring Earth ground fault detection circuit 318 of source side circuitry 210 to detect an Earth ground fault by detecting a voltage or current drop that is unexpected and likely indicative of a short to Earth (Earth ground fault).

At block 555, the method 500 includes configuring the source side circuitry 210 of the fire alarm system 100 and/or the fire alarm system 100 itself to be at least partially based on a Standard. In an aspect, the source side circuitry 210 and/or the fire alarm system 100 are based on the Gigabit Home Networking (G. hn) standard of an International Telecommunication Union Telecommunication Standardization sector (ITU-T). In another aspect, the source side circuitry and/or the fire alarm system 100 itself are based on the 10BASE-T1L Ethernet standard, also known as IEEE 802.3cg, developed and published by the Institute of Electrical and Electronics Engineers (IEEE). In an aspect, block 555 may involve configuring the FACP 110 and/or the one or more remote devices and/or the one or more repeaters 240 to have certain values expected by, or specified in, a standard.

At block 560, the method 500 includes monitoring, by a current monitoring circuit 315 of the source side circuitry 210, current from a DC power source 314 to supply DC power for transmission over the single wire pair 330. In an aspect, block 560 may involve comparing values at ends of a resistor 316 by a comparator 317 to provide an output signal on line 315C to a controller (e.g., one or more processors 119) that is indicative of an existing fault state (no fault, open fault or short fault or overload fault).

At block 565, the method 500 includes providing a visual and/or audible alarm on FACP 110 using a speaker 113 or a display 113 of FACP 110 responsive to the detection of a fault. In an aspect, the type of fault (open fault versus short fault versus overload fault versus Earth ground fault) may be indicated visually and/or audibly.

At block 570, the method 500 includes preventing DC power source 314 from providing power to the one or more repeaters 240 to prevent local and/or downstream damage, responsive to the detection of a fault.

Additional aspects of the present disclosure may include one or more of the following clauses.

Clause 1. A fire alarm system using a single wire pair, the fire alarm system comprising: source side circuitry having: a data communication interface configured to couple to the single wire pair, a power communication interface configured to couple to the single wire pair, and fault detection circuitry configured to detect specific power-related faults occurring on the single wire pair, wherein the data communication interface and the power communication interface respectively communicate data and power over the single wire pair.

Clause 2. The fire alarm system in accordance with clause 1, wherein the source side circuitry is further configured to perform fault detection of the specific power-related faults occurring at the source side circuitry.

Clause 3. The fire alarm system in accordance with any preceding clauses, wherein the source side circuitry is configured to detect at least one of an open circuit fault, an Earth ground fault, a short circuit fault, or an overload fault occurring on the single wire pair.

Clause 4. The fire alarm system in accordance with any preceding clauses, wherein the source side circuitry corresponds to a fire alarm control panel (FACP) portion of the fire alarm system configured to connect to another FACP of the fire alarm system over the single wire pair.

Clause 5. The fire alarm system in accordance with any preceding clauses, further comprising target side circuitry having: a data communication interface configured to couple to the single wire pair, and a power communication interface configured to couple to the single wire pair.

Clause 6. The fire alarm system in accordance with any preceding clauses, wherein the source side circuitry and the target side circuitry are configured to perform a handshake, prior to and as a condition of allowing power to be transmitted between the source side circuitry and the target side circuitry, to confirm that a connection is intended between the source side circuitry and the target side circuitry.

Clause 7. The fire alarm system in accordance with any preceding clauses, wherein the source side circuitry corresponds to a fire alarm control panel (FACP) and the target side circuitry corresponds to another FACP.

Clause 8. The fire alarm system in accordance with any preceding clauses, wherein the source side circuitry comprises a current monitor for monitoring current from a DC power source, the DC power source being configured to supply DC power for transmission over the single wire pair.

Clause 9. The fire alarm system in accordance with any preceding clauses, further comprising a current monitoring circuit having: one or more resistors connected to the DC power source; a comparator for detecting a current flowing through the one or more resistors; and a controller for indicating a fault type from among open circuit faults, short circuit faults, and overload faults, responsive to the current detected by the comparator flowing through the one or more resistors.

Clause 10. The fire alarm system in accordance with any preceding clauses, further comprising one or more repeaters connected between the source side circuitry and target side circuitry of the fire alarm system.

Clause 11. The fire alarm system in accordance with any preceding clauses, wherein the one or more repeaters are configured to extend a distance separating the source side circuitry and the target side circuitry while maintaining a minimum threshold quality level.

Clause 12. The fire alarm system in accordance with any preceding clauses, wherein the source side circuitry and one or more repeaters are configured to perform a handshake, prior to and as a condition of allowing power to be transmitted from the source side circuitry to the one or more repeaters, to confirm that a connection is intended between the source side circuitry and the one or more repeaters.

Clause 13. The fire alarm system in accordance with any preceding clauses, wherein the source side circuitry is configured to interface with a fire alarm control panel (FACP) of the fire alarm system, and wherein the target side circuitry is configured to interface with another FACP of the fire alarm system.

Clause 14. The fire alarm system in accordance with any preceding clauses, wherein the one or more repeaters are configured to extend a distance separating the source side circuitry and the target side circuitry while maintaining a minimum threshold quality level.

Clause 15. The fire alarm system in accordance with any preceding clauses, wherein the minimum threshold quality level is based on monitoring at least one of a data communication component and a power communication component of a received signal.

Clause 16. The fire alarm system in accordance with any preceding clauses, wherein the minimum threshold quality level is based on monitoring a delay of a received signal.

Clause 17. The fire alarm system in accordance with any preceding clauses, wherein the one or more repeaters are added to the fire alarm system based on monitoring respective minimum threshold quality levels determined for an amount of received data and an amount of received power.

Clause 18. The fire alarm system in accordance with any preceding clauses, wherein the data communication interface in the source side circuitry and a data communication interface in the target side circuitry is for coupling a respective data communication circuit to the single wire pair.

Clause 19. The fire alarm system in accordance with any preceding clauses, wherein at least one repeater of the one or more repeaters comprises: a communications repeater for regenerating signals passing through the at least one repeater; and a power reconditioner configured to boost a voltage level of a received signal to at least a minimum voltage level.

Clause 20. A method for providing data and power over a single wire pair in a fire alarm system, the method comprising: coupling, by a data communication interface of source side circuitry, the single wire pair to a data communication circuit; coupling, by a power communication interface of the source side circuitry, the single wire pair to a DC power source; and detecting, by fault detection circuitry of the source side circuitry, specific power-related faults occurring on the single wire pair, wherein the data communication interface and the power communication interface respectively communicate data and power over the single wire pair.

Various aspects of the disclosure may take the form of an entirely or partially hardware aspect, an entirely or partially software aspect, or a combination of software and hardware. Furthermore, as described herein, various aspects of the disclosure (e.g., systems and methods) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit the performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read-only memory (ROM); random access memory (RAM); magnetic disk storage media; optical storage media; flash memory, and so forth.

Aspects of this disclosure are described herein with reference to block diagrams and flowchart illustrations of methods, systems, apparatuses, and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general-purpose computer, a special-purpose computer, or another programmable information processing apparatus to produce a particular machine, such that the operations or functions specified in the flowchart block or blocks can be implemented in response to execution at the computer or processing apparatus.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps, or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to the arrangement of steps or operational flow; plain meaning derived from grammatical organization or punctuation; the number or type of aspects described in the specification or annexed drawings; or the like.

As used in this disclosure, including the annexed drawings, the terms “component,” “module,” “system,” and the like are intended to refer to a computer-related entity or an entity related to an apparatus with one or more specific functionalities. The entity can be either hardware, a combination of hardware and software, software, or software in execution. One or more of such entities are also referred to as “functional elements.” As an example, a component can be a process running on a processor, a processor, an object, an executable, a thread of execution, a program, and/or a computer. For example, both an application running on a server or network controller, and the server or network controller can be a component. One or more components can reside within a process and/or thread of execution and a component can be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which parts can be controlled or otherwise operated by program code executed by a processor. As yet another example, a component can be an apparatus that provides specific functionality through electronic components without mechanical parts, the electronic components can include a processor to execute program code that provides, at least partially, the functionality of the electronic components. As still another example, interface(s) can include I/O components or Application Programming Interface (API) components. While the foregoing examples are directed to aspects of a component, the exemplified aspects or features also apply to a system, module, and similar.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in this specification and annexed drawings should be construed to mean “one or more” unless specified otherwise or clear from context to be directed to a singular form.

In addition, the terms “example” and “such as” and “e.g.” are utilized herein to mean serving as an instance or illustration. Any aspect or design described herein as an “example” or referred to in connection with a “such as” clause or “e.g.” is not necessarily to be construed as preferred or advantageous over other aspects or designs described herein. Rather, use of the terms “example” or “such as” or “e.g.” is intended to present concepts in a concrete fashion. The terms “first,” “second,” “third,” and so forth, as used in the claims and description, unless otherwise clear by context, is for clarity only and does not necessarily indicate or imply any order in time or space.

The term “processor,” as utilized in this disclosure, can refer to any computing processing unit or device comprising processing circuitry that can operate on data and/or signaling. A computing processing unit or device can include, for example, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can include an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. In some cases, processors can exploit nano-scale architectures, such as molecular and quantum-dot based transistors, switches and gates, in order to optimize space usage or enhance performance of user equipment. A processor may also be implemented as a combination of computing processing units.

In addition, terms such as “store,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can include both volatile and nonvolatile memory. Moreover, a memory component can be removable or affixed to a functional element (e.g., device, server).

Simply as an illustration, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Various aspects described herein can be implemented as a method, apparatus, or article of manufacture using special programming as described herein. In addition, various of the aspects disclosed herein also can be implemented by means of program modules or other types of computer program instructions specially configured as described herein and stored in a memory device and executed individually or in combination by one or more processors, or other combination of hardware and software, or hardware and firmware. Such specially configured program modules or computer program instructions, as described herein, can be loaded onto a general-purpose computer, a special-purpose computer, or another type of programmable data processing apparatus to produce a machine, such that the instructions which execute on the computer or other programmable data processing apparatus create a means for implementing the functionality of disclosed herein.

The term “article of manufacture” as used herein is intended to encompass a computer program accessible from any non-transitory computer-readable device, carrier, or media. For example, computer readable media can include but are not limited to magnetic storage devices (e.g., hard drive disk, floppy disk, magnetic strips, or similar), optical discs (e.g., compact disc (CD), digital versatile disc (DVD), Blu-ray disc (BD), or similar), smart cards, and flash memory devices (e.g., card, stick, key drive, or similar).

The detailed description set forth herein in connection with the annexed figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well-known components are shown in block diagram form, while some blocks may be representative of one or more well-known components.

The previous description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A fire alarm system using a single wire pair, the fire alarm system comprising:
source side circuitry having:
a data communication interface configured to couple to the single wire pair,
a power communication interface configured to couple to the single wire pair, and
fault detection circuitry configured to detect specific power-related faults occurring on the single wire pair,
wherein the data communication interface and the power communication interface respectively communicate data and power over the single wire pair.

2. The fire alarm system in accordance with claim 1, wherein the source side circuitry is further configured to perform fault detection of the specific power-related faults occurring at the source side circuitry.

3. The fire alarm system in accordance with claim 1, wherein the source side circuitry is configured to detect at least one of an open circuit fault, an Earth ground fault, a short circuit fault, or an overload fault occurring on the single wire pair.

4. The fire alarm system in accordance with claim 1, wherein the source side circuitry corresponds to a fire alarm control panel (FACP) portion of the fire alarm system configured to connect to another FACP of the fire alarm system over the single wire pair.

5. The fire alarm system in accordance with claim 1, further comprising target side circuitry having:
a data communication interface configured to couple to the single wire pair, and
a power communication interface configured to couple to the single wire pair.

6. The fire alarm system in accordance with claim 5, wherein the source side circuitry and the target side circuitry are configured to perform a handshake, prior to and as a condition of allowing power to be transmitted between the source side circuitry and the target side circuitry, to confirm that a connection is intended between the source side circuitry and the target side circuitry.

7. The fire alarm system in accordance with claim 5, wherein the source side circuitry corresponds to a fire alarm control panel (FACP) and the target side circuitry corresponds to another FACP.

8. The fire alarm system in accordance with claim 1, wherein the source side circuitry comprises a current monitor for monitoring current from a DC power source, the DC power source being configured to supply DC power for transmission over the single wire pair.

9. The fire alarm system in accordance with claim 8, further comprising a current monitoring circuit having:
one or more resistors connected to the DC power source;
a comparator for detecting a current flowing through the one or more resistors; and
a controller for indicating a fault type from among open circuit faults, short circuit faults, and overload faults, responsive to the current detected by the comparator flowing through the one or more resistors.

10. The fire alarm system in accordance with claim 1, further comprising one or more repeaters connected between the source side circuitry and target side circuitry of the fire alarm system.

11. The fire alarm system in accordance with claim 10, wherein the one or more repeaters are configured to extend a distance separating the source side circuitry and the target side circuitry while maintaining a minimum threshold quality level.

12. The fire alarm system in accordance with claim 10, wherein the source side circuitry and one or more repeaters are configured to perform a handshake, prior to and as a condition of allowing power to be transmitted from the source side circuitry to the one or more repeaters, to confirm that a connection is intended between the source side circuitry and the one or more repeaters.

13. The fire alarm system in accordance with claim 10, wherein the source side circuitry is configured to interface with a fire alarm control panel (FACP) of the fire alarm system, and wherein the target side circuitry is configured to interface with another FACP of the fire alarm system.

14. The fire alarm system in accordance with claim 10, wherein the one or more repeaters are configured to extend a distance separating the source side circuitry and the target side circuitry while maintaining a minimum threshold quality level.

15. The fire alarm system in accordance with claim 14, wherein the minimum threshold quality level is based on monitoring at least one of a data communication component and a power communication component of a received signal.

16. The fire alarm system in accordance with claim 14, wherein the minimum threshold quality level is based on monitoring a delay of a received signal.

17. The fire alarm system in accordance with claim 10, wherein the one or more repeaters are added to the fire alarm system based on monitoring respective minimum threshold quality levels determined for an amount of received data and an amount of received power.

18. The fire alarm system in accordance with claim 10, wherein the data communication interface in the source side circuitry and a data communication interface in the target side circuitry is for coupling a respective data communication circuit to the single wire pair.

19. The fire alarm system in accordance with claim 10, wherein at least one repeater of the one or more repeaters comprises:
a communications repeater for regenerating signals passing through the at least one repeater; and a power reconditioner configured to boost a voltage level of a received signal to at least a minimum voltage level.

20. A method for providing data and power over a single wire pair in a fire alarm system, the method comprising:
coupling, by a data communication interface of source side circuitry, the single wire pair to a data communication circuit;
coupling, by a power communication interface of the source side circuitry, the single wire pair to a DC power source; and
detecting, by fault detection circuitry of the source side circuitry, specific power-related faults occurring on the single wire pair,
wherein the data communication interface and the power communication interface respectively communicate data and power over the single wire pair.
